(19) United States
(12) Patent Application Publication
(10) Pub. No.: US 2010/0095138 A1
(43) Pub. Date: Apr. 15, 2010

(54) COMPUTER START-UP TIMING CONTROL DEVICE AND METHOD THEREOF

(75) Inventors: Lan Huang, Shanghai City (CN); Shih-Hao Liu, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/401,081

(22) Filed: Mar. 10, 2009

(30) Foreign Application Priority Data
Oct. 10, 2008 (CN) 200810166532.7

(51) Int. Cl. G06F 1/00

(52) U.S. Cl. 713/300

(57) ABSTRACT

A computer start-up timing control device and a method thereof are provided for generating a power supply signal to enable a power supply unit (PSU) to provide power. The device includes a chipset, a delay circuit, and a logic gate. The delay circuit delays a standby power ready signal of the computer to generate a standby power delay signal. The chipset generates a power supply signal. The standby power delay signal enables the logic gate to transmit the power supply signal to the PSU via the logic gate. The PSU provides a power to make the computer enter a start-up procedure. The standby power delay signal delays the time for the chipset to send a power supply signal, so that a baseboard management controller (BMC) has enough time to complete initialization. Therefore, the chipset is prevented from accessing the BMC and obtaining erroneous information before the BMC finishes initialization.

### CROSS-REFERENCE TO RELATED APPLICATION

This application claims the priority benefit of China application serial no. 200810166532.7, filed Oct. 10, 2008. The entirety of the above-mentioned patent application is hereby incorporated by reference herein and made a part of specification.

### BACKGROUND OF THE INVENTION

1. Field of the Invention

The present invention generally relates to a computer, in particular, to a computer start-up timing control device and a method thereof.

2. Description of Related Art

On a conventional computer platform, chipsets are generally adopted to simplify the architecture of the computer hardware, and a number of integrated circuits (ICs) with different functions are integrated into individual chipsets. The chipsets are coupled with one another via buses for information transmission. In the past, a basic input output system (BIOS) is employed to manage the underlying information of a computer, and nowadays the chipsets are used to replace some of the functions of the BIOS so as to enhance the operating efficiency of the system.

Currently, a computer platform is generally equipped with an intelligent platform management interface (IPMI). The function of the IPMI is embodied by a baseboard management controller (BMC). The BMC is mainly in charge of a communication interface, including a human-machine interface (HMI), on the physical layer of a computer, and capable of monitoring the start-up and shut-down of the computer. Some hardware devices on the mainboard of the computer are provided with sensors. The BMC collects the information fed back by each sensor and reports to the system administrator right away when detecting any error.

After the computer is powered on, a power supply unit (PSU) provides a standby power for the BMC and other chipsets. The BMC, after completing the initialization, monitors the operating information of the computer hardware and stands by for start-up. During the initialization of the BMC, if a user starts the computer, other chipsets will issue requests to the BMC upon functional requirements, and the BMC may feed back incorrect hardware information, such that unexpected errors may occur and cause potential problems in the system operation.

FIG. 1 is an architectural view of a conventional start-up timing control device. The architecture of the conventional start-up timing control device in FIG. 1 is incomplete, and only a PSU 50, an HMI 120, a BMC 130, and a chipset 140 are shown. Those of ordinary skill in the art should understand that, in the conventional start-up timing control, the PSU 50 outputs a standby power to the BMC 130 after the computer is powered on and then the BMC 130 starts initialization. The HMI 120 includes a start-up button. When the start-up button is pressed, the HMI 120 sends a start-up signal to the chipset 140, and the chipset 140 generates a power supply signal to the PSU 50 so as to provide the computer with an operating power for start-up. FIGS. 2A to 2B are timing diagrams of internal signals of a conventional start-up timing control device.

Referring to FIG. 2A, after the computer is powered on, when the PSU 50 outputs a standby power P3V3_STBY to the BMC 130, an operating status BMC_{DUTY} of the BMC 130 is in a period S_{INIT}, indicating that the BMC 130 starts initialization. At the end of the period S_{INIT}, the start-up button on the HMI 120 is pressed, the HMI 120 sends a start-up signal S_{ON} to the chipset 140, and the chipset 140 generates a power supply signal ICH_SLP4 to the PSU 50 for providing the computer with an operating power for start-up. At this point, the chipset 140 accesses the BMC 130 (in a period S_{REQ1} of an operating status SB_{DUTY}), and the BMC 130 feeds back an information to the chipset 140 (in a period S_{RSP1} of the operating status BMC_{DUTY}).

The conventional start-up timing control device suffers from a problem in that, after the PSU 50 generates the standby power P3V3_STBY, the BMC 130 carries out the initialization according to the standby power P3V3_STBY. Before the initialization is completed, the start-up button on the HMI 120 is pressed, such that the start-up signal S_{ON} is forwarded by the BMC 130 to the chipset 140, and the chipset 140 accordingly sends a standby power ready signal PGD_P3V3_STBY to the PSU 50. Referring to FIG. 2B, if the chipset 140 accesses the BMC 130 and requests for system information on the computer platform (in a period S_{REQ2} of the operating status SB_{DUTY}) at this point, errors may occur in the information fed back to the chipset 140 because the BMC 130 has not yet finished the initialization (in a period S_{RSP2} of the operating status BMC_{DUTY}), thus resulting in an unstable operation of the computer platform.

### SUMMARY OF THE INVENTION

Accordingly, the present invention is directed to a computer start-up timing control device employing a delay circuit to delay a standby power ready signal generated by a power supply unit (PSU) of a computer platform. The delayed standby power ready signal is sent after a baseboard management controller (BMC) has finished initialization. Here, the delay standby power ready signal is used for controlling the transmission of a power supply signal to the PSU, so as to prevent other chipsets from accessing the BMC due to the start-up of the computer and obtaining erroneous information during the initialization of the BMC.

A computer start-up timing control device for generating a power supply signal to enable a PSU to provide power includes a chipset, a delay circuit, and a logic gate. The chipset generates the power supply signal. The PSU generates a standby power ready signal indicating that the standby power in the computer is ready. The delay circuit receives and delays the standby power ready signal to be output as a control signal of the logic gate, and the logic gate is coupled to the chipset and the delay circuit. The logic gate outputs the power supply signal to the PSU according to the delayed standby power ready signal. The power supply signal is used for informing the PSU to enter a start-up procedure and providing a system power for the computer.

In an embodiment of the present invention, the above computer start-up timing control device further includes a human-machine interface (HMI) and a BMC that is coupled between the HMI and the chipset. The HMI is operated by a user of the computer to generate a start-up signal. The BMC receives the start-up signal and forwards the same to the chipset.

In an embodiment of the present invention, the HMI includes a start-up button for generating the start-up signal.

In an embodiment of the present invention, after the PSU provides the BMC with the standby power, the BMC starts initialization. The delay circuit delays the output of the standby power ready signal by a time longer than the initialization time of the BMC.

In an embodiment of the present invention, the delay circuit delays the standby power ready signal by 8 ms to be output as the control signal of the logic gate.

In an embodiment of the present invention, the logic gate is an AND gate. The chipset is coupled to an input end of the AND gate for providing the power supply signal, and the delay circuit is coupled to the other input end of the AND gate for providing a delayed standby power ready signal. An output end of the AND gate is coupled to a PSU.

In an embodiment of the present invention, the logic gate includes a transmission gate and a NOT gate. The chipset is coupled to an input end of the transmission gate for providing the power supply signal, and the delay circuit is coupled to a control terminal of the transmission gate for providing the delayed standby power ready signal. The delay circuit is also coupled to an inverse control terminal of the transmission gate via the NOT gate. An output end of the transmission gate is coupled to the PSU.

A computer start-up timing control method for enabling a power supply unit (PSU) to provide power includes the following steps. A power supply signal is generated by a chipset. A standby power ready signal is delayed by a delay circuit and output as a gate control signal. The standby power ready signal indicates that the standby power in the computer is ready. It is determined whether to transmit the power supply signal to the PSU according to the gate control signal.

In an embodiment of the present invention, the chipset is a south bridge chip.

In an embodiment of the present invention, the standby power is provided for a baseboard management controller (BMC) as an operating power.

In an embodiment of the present invention, a time required by the BMC from being provided with the standby power to being capable of a normal operation is an initialization time of the BMC, and the standby power ready signal is delayed by a time longer than the initialization time of the BMC.

In an embodiment of the present invention, the standby power ready signal is delayed by about 8 ms to be output as the gate control signal.

A chipset accessing the BMC inside the computer platform before the completion of the initialization of the BMC may obtain erroneous information, and thus the system becomes unstable. Therefore, the present invention provides a computer start-up timing control device and a method thereof for delaying the initialization of the chipset, such that the BMC finishes initialization before being accessed by the chipset.

Though a general description of the technical solution of the present invention is given above, in order to further understand the technical means of the invention and implement the invention according to the content of the specification, embodiments are illustrated in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architectural view of a conventional start-up timing control device.

FIGS. 2A to 2B are timing diagrams of internal signals of a conventional start-up timing control device.

FIG. 3 is an architectural view of a computer start-up timing control device according to the present invention.

FIGS. 4A to 4B are structural views of a logic gate according to an embodiment of the present invention.

FIG. 5 is a timing diagram of internal signals of a start-up timing control device according to an embodiment of the present invention.

FIG. 6 is a flow chart of a computer start-up timing control method according to the present invention.

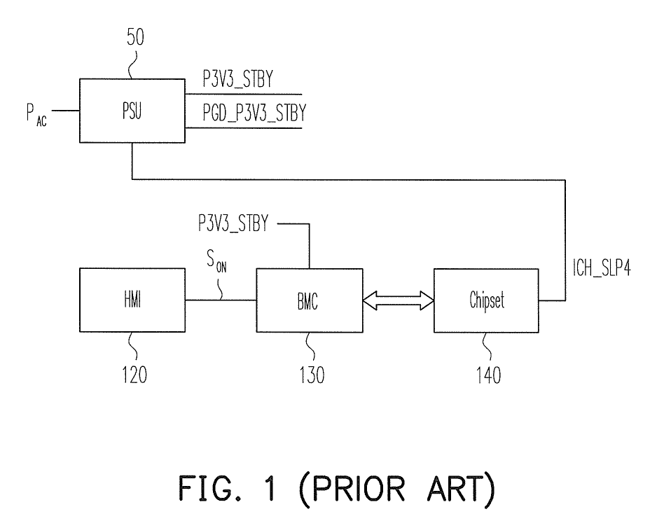

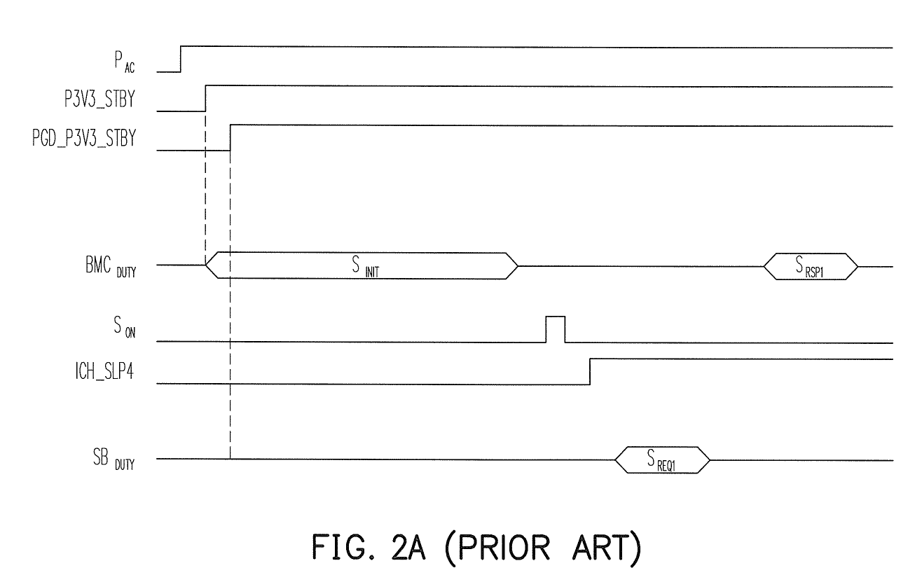

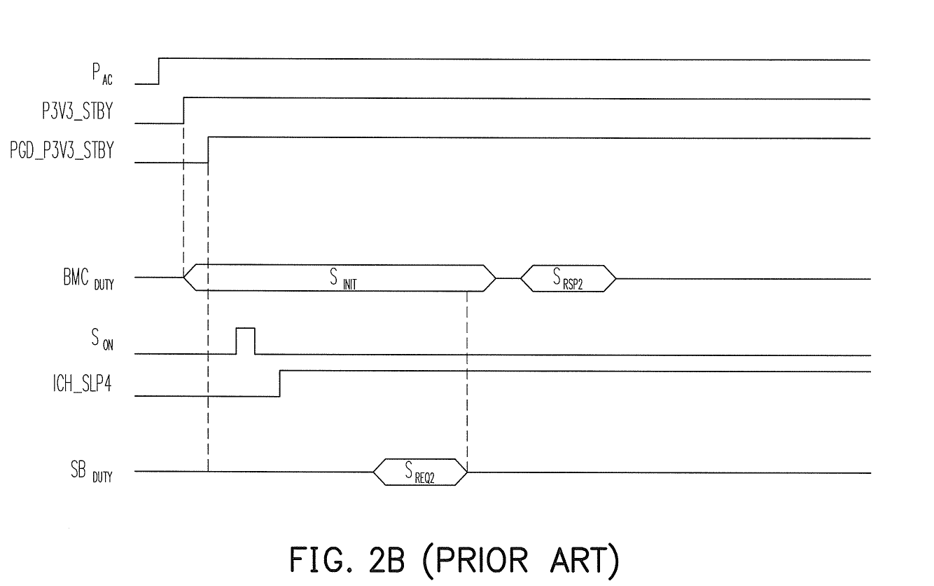

### DESCRIPTION OF THE EMBODIMENTS

The features and effects of the start-up timing control device provided by the present invention are described in detail below in embodiments with the accompanying drawings.

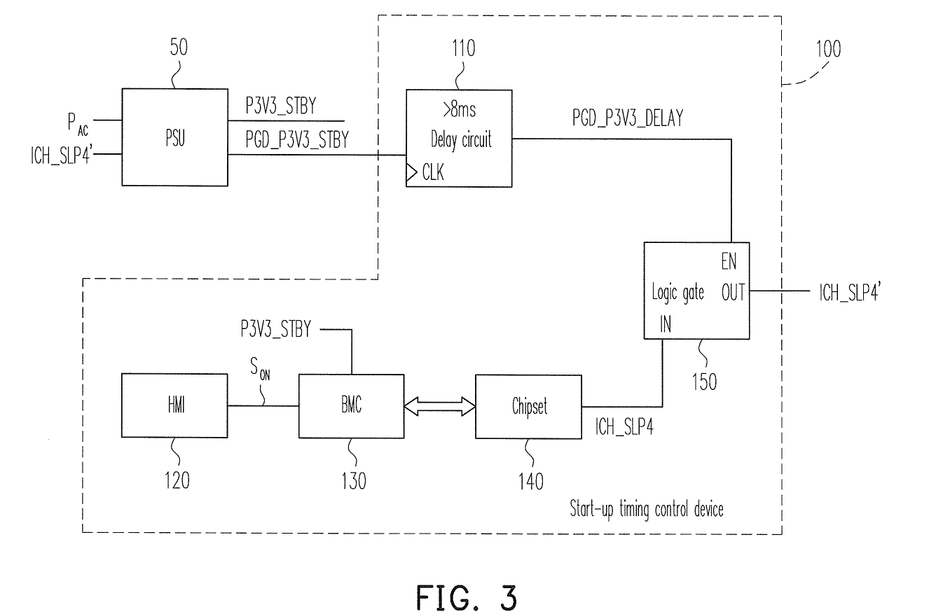

Those of ordinary skill in the art should understand that, the start-up timing control in a computer involves the interaction of a plurality of hardware components. A computer start-up timing control device provided by the present invention utilizes a delay circuit to delay a standby power ready signal generated by a PSU of the computer platform and to send the delayed standby power ready signal after the BMC finishes initialization, so as to prevent the chipset from sending a power supply signal ahead of time. Thereby, unexpected system errors resulted from the obtaining of error information of other hardware components by accessing the BMC can be avoided. FIG. 3 is an architectural view of a computer start-up timing control device according to the present invention. The start-up timing control device 100 includes a chipset 140, a delay circuit 110, and a logic gate 150.

After the computer is powered on, an external power P_{AC} is input to the PSU 50. Before receiving a power supply signal ICH_SLP4′, the PSU 50 only provides a standby power to the computer instead of providing the system power. The standby power required by the computer can be one or more types of power, and only a standby power P3V3_STBY is shown in FIG. 3. At this point, only a few hardware devices on the computer platform need the standby power P3V3_STBY for operation, and the other hardware devices remain in an idle state. The PSU 50 is coupled to the delay circuit 110, and a regulator inside the PSU 50 provides a standby power ready signal PGD_P3V3_STBY to the delay circuit 110. The standby power ready signal PGD_P3V3_STBY indicates that the standby power P3V3_STBY in the computer is ready. The delay circuit 110 coupled to the logic gate 150 generates a standby power delay signal PGD_P3V3_DELAY and outputs the same to the logic gate 150 according to the standby power ready signal PGD_P3V3_STBY. Here, the standby power delay signal PGD_P3V3_DELAY serves as a control signal of the logic gate 150. When the chipset 140 generates a power supply signal ICH_SLP4 and transmits the same to the logic gate 150, the standby power delay signal PGD_P3V3_DELAY enables the logic gate 150, and thus the power supply signal ICH_SLP4 is sent from an output end of the logic gate 150 as a power supply signal ICH_SLP4′. The logic gate 150 coupled to the PSU 50 generates the power supply signal ICH_SLP4′ and outputs the same to the PSU 50, such that the PSU 50 enters a start-up status and provides a system power required for a normal operation of the computer platform to start up.

In the software planning of the conventional computer platform, some of the functions of the BIOS have been integrated into a chip or a chipset. Thereby, the burden on the computer platform is alleviated and the efficiency of the system is enhanced when a preliminary initialization of the system is completed before start-up. Referring to FIG. 3, a computer start-up timing control device of the present invention further includes an HMI 120 and a BMC 130. As described above, the BMC 130 is one of the few hardware components requiring power for operation when the external power P_{AC} is input to the PSU 50 after the power-on of the computer. Those of ordinary skill in the art should understand that, some of the hardware components on the computer platform are equipped with sensors for monitoring conditions of the system, such as temperature and voltages, and the BMC 130 monitors the sensors and collects information for the access by an operation system (OS). Therefore, the details will not be described herein. The HMI 120 to be operated by a user of the computer serves as a communication interface between the user and the computer platform. According to an embodiment of the present invention, the HMI 120 includes a start-up button. However, those of ordinary skill in the art can adopt other devices with an on/off function as the HMI 120 according to the description of this embodiment.

The BMC 130 is coupled between the HMI 120 and the chipset 140. When the user of the computer presses the start-up button, a start-up signal S_{ON} is generated and transmitted to the BMC 130. Upon receiving the start-up signal S_{ON}, the BMC 130 accesses the chipset 140, and the chipset 140 sends the power supply signal ICH_SLP4 according to the start-up signal S_{ON}. In an embodiment of the present invention, the chipset 140 is a south bridge chip. Similarly, the chipset 140 can also be other devices capable of accessing the BMC 130 and sending the power supply signal ICH_SLP4.

After the PSU 50 supplies the BMC 130 with the standby power P3V3_STBY, the BMC 130 starts initialization. According to an embodiment of the present invention, in order to prevent the computer from entering the start-up procedure before the BMC 130 finishes initialization, the delay circuit 110 delays the standby power ready signal PGD_P3V3_STBY to be output as a standby power delay signal PGD_P3V3_DLAY for controlling the time for the power supply signal ICH_SLP4 to be transmitted to the PSU 50. The time during which the delay circuit 110 is effectuated is longer than the time required for the BMC 130 to accomplish initialization. In an embodiment of the present invention, the delay circuit 110 delays the standby power ready signal PGD_P3V3_STBY by 8 ms to be output as the control signal of the logic gate 150.

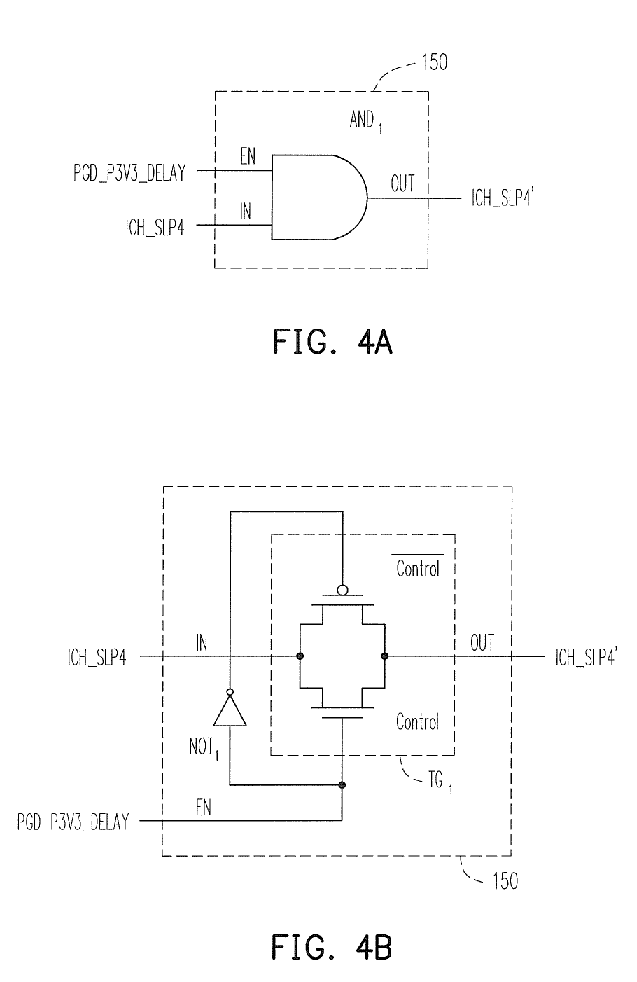

As described above, the access by the chipset 140 to the BMC 130 must be restricted until the BMC 130 finishes initialization. FIG. 4A is a structural view of a logic gate according to an embodiment of the present invention in which the logic gate 150 is an AND gate AND₁. Referring to FIG. 4A, an input end EN of the AND gate AND₁ is coupled to the delay circuit 110 for receiving the standby power delay signal PGD_P3V3_DELAY generated by the delay circuit 110 as the control signal for the AND gate AND₁. The other input end IN of the AND gate AND₁ is coupled to the chipset 140 for receiving the power supply signal ICH_SLP4 generated by the chipset 140 as the input signal for the AND gate AND₁. An output end OUT of the AND gate AND₁ is coupled to the PSU 50 so that when the AND gate AND₁ receives a standby power delay signal PGD_P3V3_DELAY (at a high level) and a power supply signal ICH_SLP4 (at a high level), the output end OUT of the AND gate AND₁ outputs a power supply signal ICH_SLP4′ (at a high level).

In another embodiment, the logic gate 150 includes a transmission gate TG₁ and a NOT gate NOT₁. Those of ordinary skill in the art can employ any logic gate or any circuit with equivalent functions to the AND gate or the transmission gate according to this embodiment. Referring to FIG. 4B, a control terminal Control of the transmission gate TG₁ is coupled to the delay circuit 110 for receiving the standby power delay signal PGD_P3V3_DELAY generated by the delay circuit 110 as a control signal for the transmission gate TG₁. The control terminal Control of the transmission gate TG₁ is coupled to an inverse control terminal C̅o̅n̅t̅r̅o̅l̅ of the transmission gate TG₁ via the NOT gate NOT₁, and an inverse signal of the standby power delay signal PGD_P3V3_DELAY generated by the delay circuit 110 serves as an inverse control signal for the transmission gate TG₁. An input end IN of the transmission gate TG₁ is coupled to the chipset 140 for receiving the power supply signal ICH_SLP4 generated by the chipset 140 as an input signal for the transmission gate TG₁. An output end OUT of the transmission gate TG₁ is coupled to the PSU 50, such that when the transmission gate TG₁ receives a standby power delay signal PGD_P3V3_DELAY (at a high level) and a power supply signal ICH_SLP4 (at a high level), the output end OUT of the transmission gate TG₁ outputs a power supply signal ICH_SLP4′ (at a high level).

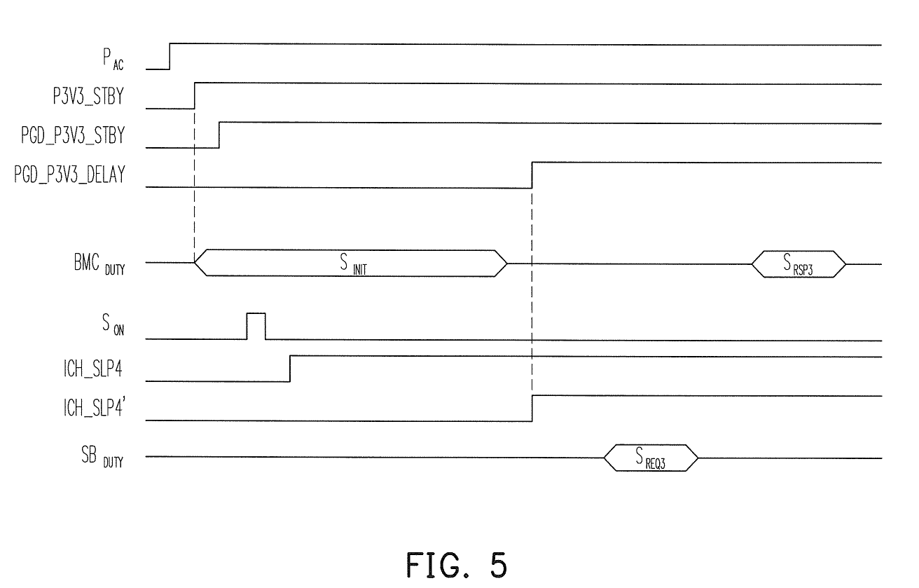

FIG. 5 is a timing diagram of internal signals of a start-up timing control device according to an embodiment of the present invention. In this embodiment, the PSU 50 generates a standby power P3V3_STBY and transmits the same to the BMC 130 for starting initialization, and thereafter, the PSU 50 generates a standby power ready signal PGD_P3V3_STBY When the start-up button on the HMI 120 is pressed, the HMI 120 generates a start-up signal S_{ON} to the chipset 140. Referring to FIG. 5, the chipset 140 generates a power supply signal ICH_SLP4 which cannot be immediately transmitted to the PSU 50. The standby power ready signal PGD_P3V3_STBY is delayed by the delay circuit 110 as a standby power delay signal PGD_P3V3_DELAY. After the standby power delay signal PGD_P3V3_DELAY is output to the logic gate 150, the power supply signal ICH_SLP4 is output via the logic gate 150 as the power supply signal ICH_SLP4′, and the PSU 50 provides power for the computer according to the power supply signal ICH_SLP4′, The chipset 140 then accesses the BMC 130 (in a period S_{REQ3} of the operating status SB_{DUTY}). As the BMC 130 has finished initialization, the BMC 130 feeds back the right information to the chipset 140 (in a period S_{RSP3} of the operating status BMC_{DUTY}).

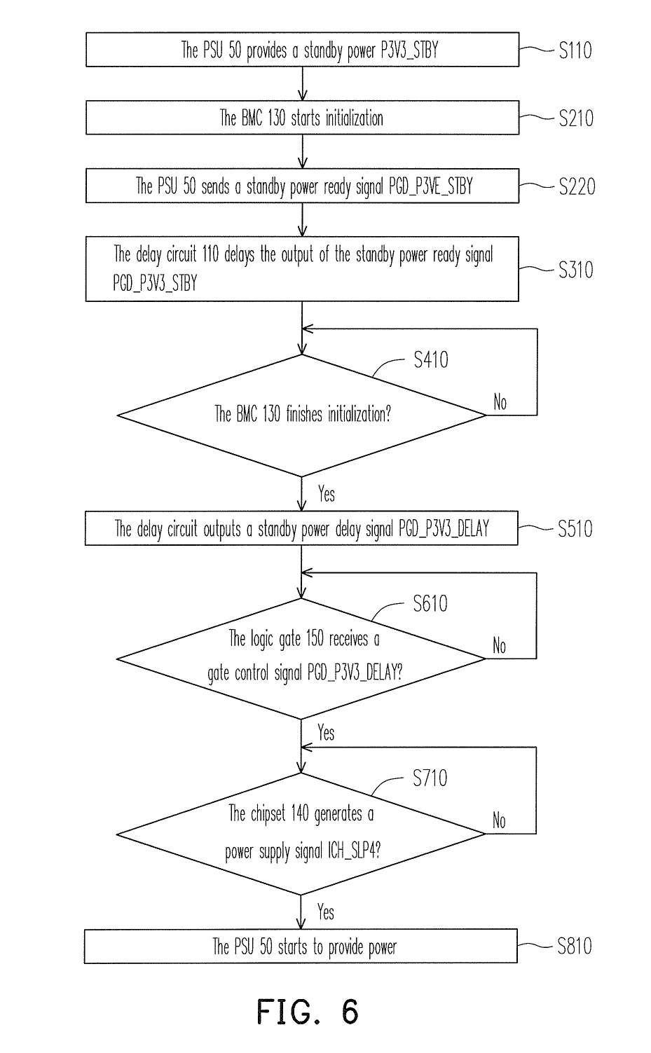

FIG. 6 is a flow chart of a computer start-up timing control method according to the present invention. In the method, a power supply signal is generated by a chipset, and a standby power ready signal is delayed by a delay circuit to be output as a gate control signal of a logic gate. Next, a PSU supplies a standby power to a BMC for starting initialization. The standby power ready signal indicates that the standby power in the computer is ready. The logic gate determines whether to transmit the power supply signal to the PSU according to the gate control signal.

Referring to FIG. 6, the PSU 50 supplies a standby power P3V3_STBY to the BMC 130 (Step S110), and the BMC 130 starts initialization (Step S210). Thereafter, the PSU 50 sends a standby power ready signal PGD_P3V3_STBY indicating that the standby power P3V3_STBY in the computer is ready (Step S220). In this embodiment, the chipset 140 is a south bridge chip. When the chipset 140 generates a power supply signal ICH_SLP4, the PSU 50 does not provide power for the computer platform. The delay circuit 110 delays the output of the standby power ready signal PGD_P3V3_STBY (Step S310) by 8 ms in this embodiment. The delay circuit 110 outputs the standby power ready signal PGD_P3V3_STBY as a standby power delay signal PGD_P3V3_DELAY (Step S410) after the BMC 130 has finished initialization. After the initialization is completed, the delay circuit 110 outputs the standby power delay signal PGD_P3V3_DELAY (Step S510). The gate control signal of the logic gate 150 conducts the input and output ends of the logic gate 150 according to the standby power delay signal PGD_P3V3_DELAY (Step S610). At this point, the power supply signal ICH_SLP4 sent by the chipset 140 is forwarded to the PSU 50 to inform the PSU 50 of starting to provide the computer platform with the operating power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer start-up timing control device, for generating a power supply signal to enable a power supply unit (PSU) to provide power, the computer start-up timing control device comprising:
a chipset, for generating the power supply signal;
a delay circuit, for receiving and delaying a standby power ready signal to be output as a gate control signal, wherein the standby power ready signal indicates whether a standby power in the computer is ready; and
a logic gate, coupled to the chipset and the delay circuit, for determining whether to transmit the power supply signal generated by the chipset to the PSU according to the gate control signal.

2. The computer start-up timing control device according to claim 1, wherein the chipset is a south bridge chip.

3. The computer start-up timing control device according to claim 1, further comprising:
a human-machine interface (HMI), operated by a user to generate a start-up signal; and
a baseboard management controller (BMC), coupled between the HMI and the chipset, for forwarding the start-up signal to the chipset, wherein the BMC employs the standby power as an operating power.

4. The computer start-up timing control device according to claim 3, wherein the HMI comprises a start-up button.

5. The computer start-up timing control device according to claim 3, wherein a time required by the BMC from being provided with the standby power to being capable of a normal operation is an initialization time of the BMC, and the delay circuit delays the standby power ready signal by a time longer than the initialization time of the BMC.

6. The computer start-up timing control device according to claim 1, wherein the delay circuit delays the standby power ready signal by 8 ms to be output as the gate control signal.

7. The computer start-up timing control device according to claim 1, wherein the logic gate is an AND gate, two input ends of the AND gate are coupled to the chipset and the delay circuit respectively, and an output end thereof is coupled to the PSU.

8. The computer start-up timing control device according to claim 1, wherein the logic gate comprises a transmission gate and a NOT gate, the delay circuit is coupled to a control terminal of the transmission gate, the delay circuit is coupled to an inverse control terminal of the transmission gate via the NOT gate, an input end of the transmission gate is coupled to the chipset, and an output end of the transmission gate is coupled to the PSU.

9. A computer start-up timing control method, for enabling a power supply unit (PSU) to provide power, the method comprising:
generating a power supply signal by a chipset;
delaying a standby power ready signal to be output as a gate control signal, wherein the standby power ready signal indicates whether a standby power in the computer is ready; and
determining whether to transmit the power supply signal to the PSU according to the gate control signal.

10. The computer start-up timing control method according to claim 9, wherein the chipset is a south bridge chip.

11. The computer start-up timing control method according to claim 9, wherein the standby power is provided for a baseboard management controller (BMC) as an operating power.

12. The computer start-up timing control method according to claim 11, wherein a time required by the BMC from being provided with the standby power to being capable of a normal operation is an initialization time of the BMC, and the standby power ready signal is delayed by a time longer than the initialization time of the BMC.

13. The computer start-up timing control method according to claim 9, wherein the standby power ready signal is delayed by 8 ms to be output as the gate control signal.
